(19) United States
(12) Patent Application Publication
(10) Pub. No.: US 2024/0090508 A1
(43) Pub. Date: Mar. 21, 2024

(54) NOVEL ANTIMICROBIAL COMPOSITION OF CARBOXYLIC ACIDS WITH ALDEHYDE AND ANTIOXIDANTS COMBINATION

(71) Applicant: FERTIS INDIA PVT. LTD., Hyderabad (IN)

(72) Inventors: Rahul Raju KANUMURU, Hyderabad (IN); George Kochumalayil SHAJI, Hyderabad (IN); Lakshmi Prasanna Kumar GARUDADRI, Hyderabad (IN); Ravikumar SURANENI, Hyderabad (IN); Sil ANINDYA, Hyderabad (IN)

(21) Appl. No.: 18/282,346

(22) PCT Filed: Mar. 16, 2022
(86) PCT No.: PCT/IN2022/050253

§ 371 Date: Sep. 15, 2023

(30) Foreign Application Priority Data
Mar. 18, 2021 (IN) 202141011484

(51) Int. Cl. A01N 59/16; A01N 35/02; A01N 37/02; A01N 37/40; A01P 1/00

(52) U.S. Cl. CPC A01N 59/16; A01N 35/02; A01N 37/02; A01N 37/40; A01P 1/00

(57) ABSTRACT

The present invention discloses antimicrobial composition/formulation comprising of carboxylic acids, aldehydes and antioxidants that exhibit synergistic response to control the diseases caused by phytopathogenic microbes in agricultural crops/plants.

### FIELD OF THE INVENTION

The present invention relates to antimicrobial composition/formulation comprising of carboxylic acids, aldehydes and antioxidants that exhibit synergistic response to control the diseases caused by phytopathogenic microbes in agricultural crops/plants.

### BACKGROUND OF THE INVENTION

The ever-increasing global human population requires the continued stable production of a safe food supply with greater yields because of the shrinking areas of arable land. However, the plant diseases caused by bacteria or fungal pathogens pose a major constraint on crop production and cause significant annual losses on global scale. The effective management of these plant diseases can at times be extremely difficult due to the farmer's reliance on highly disease-susceptible cultivars because of consumer preferences, pollution, environmental conditions favouring pathogen development. One major facet in the maintenance of the sustainability of crop production and yield is identification of sustainable disease management solution for pathogenic bacterial and fungal diseases.

Relatively, few chemicals are available in the market for targeting bacterial infections though fungicidals are known. The potential use of antibiotics in controlling plant diseases are explored in the art, but similar to the emergence of bacterial strains resistant to antibiotics, its use in the management of plant diseases is limited.

Bacterial diseases of plants are very difficult to manage. In addition to visible disease symptoms, bacteria can become systemic in a plant's vascular tissue making it impractical to eradicate the pathogens by pruning out symptomatic tissues or by applying a pesticide to the plant surface. Moreover, bacteria undergo exponential growth depending on the bacterial species and environmental conditions. Thus, by the time the disease symptoms are recognized in plants, the pathogens often are entrenched and well on its way to destroying the crop. Further, the relentless use of the pesticides or fungicides are found to deplete the quality of soil, cause environmental concern, and the host pathogens eventually develop resistance which only add to the problem of the cultivators.

As a consequence of the above, there exist a need for developing new strategies to control bacteria or fungus, which are safe and environmentally acceptable.

An article titled ‘Application of organic acids for the plant protection against phytopathogens’ by Igor G. Morgunov etal published in ApplMicrobialBiotechnology (2016), discloses bactericidal, fungicidal, and nematocidal activities ofarachidonic, citric, succinic, α-ketoglutaric, palmitoleic and other organicacids of microbial origin.

The present inventors observed that there is a scope to provide novel potent combination of carboxylic acids, aldehydes and antioxidants which can effectively control the growth of phytopathogenic microbes thereby improving the production of crops with minimum harm to the environment. This remains the objective of the invention.

### SUMMARY OF THE INVENTION

In accordance with the above, the present invention provides synergistic antimicrobial composition/formulation comprising of carboxylic acids, aldehydes and antioxidants to control the diseases caused by phytopathogenic microbes in agricultural crops.

In an aspect, the present invention provides synergistic antimicrobial composition/formulation to control diseases caused by phytopathogenic microbes in agricultural crops, comprising of;
(i) Carboxylic acids selected from organic acids;
(ii) Aldehydes selected from aliphatic or aromatic aldehydes;
(iii) Antioxidants;
   wherein the ratio of carboxylic acids to aldehydes to antioxidants is in the range of 1:0.25:0.01 to 2:1:0.1.

The antimicrobial composition of the present invention may comprise of metaloxides, metal salts, alcohols, sugar alcohols, carbonyl halides, lignosulfonates, silica containing compounds, phosphate and/or phosphite containing compounds in an amount of 0.1 to 10 wt % of the total formulation

The antimicrobial composition further comprises agriculturally acceptable excipients which are safe to use and environmentally friendly in the weight ratio of 1:0.25 (composition:excipients).

The carboxylic acids in the present composition are selected from pelargonic acid, acetic acid, propionic acid, lactic acid, formic acid, capric acid, caprylic acid and such like alone or mixtures thereof at a concentration ranging between 45 to 80 wt % of the total composition.

The aldehydes in the present composition are selected from formaldehyde, cinnamaldehyde, salicylaldehyde and such like alone or mixtures thereof at a concentration ranging between 2.5 to 25 wt % of the total composition.

The antioxidants are selected from phenolic esters which include but not limited to alkyl gallates in general and propyl gallates and hexyl gallate in particular, salicylates alone or mixtures thereof in an amount of 0.1 wt % to 5 wt % of the total composition or the organic acids which include but not limited to ascorbic acid, citric acid and such like alone or mixtures thereof in an amount of 0.1 wt % to 10 wt % of the total composition.

The metal salts include but not limited to sulphates, chlorides, nitrates, phosphates and or metal oxides like nickel, cobalt, copper, zinc, Iodine etc., or mixtures thereof in an amount of 0.1 wt % to 10 wt % of total composition weight/weight ratio.

The lignosulfonates include sodium and or potassium and or magnesium and or copper and zinc and or cobalt, lignosulfonates in an amount ranging from 0.1 wt % to 10 wt % of total composition weight/weight ratio.

The antimicrobial composition of the present invention is effective against the phytopathogenic fungi belonging to the following classes: Oomycetes (e.g., Pythium, Phytophthora, Peronospora, Albugo); Ascomycetes (e.g., Venturia, Podosphaera, Erysiphe, Monilinia, Uncinula); Basidiomycetes (e.g., the genera Hemileia, Rhizoctonia, Puccinia); Fungi imperfecti (e.g., Botrytis, Helminthosporium, Fusarium, Septoria, Cercospora, Alternaria and, especially, Pyricularia) and the like.

The antimicrobial composition of the present invention primarily controls the bacterial and fungal diseases like Black rot (Xanthomonascampestrispv. campestris), Bacterial canker (Clavibactermichiganensispv. michiganensis), Bacterial soft rot (Pseudomonas spp., Erwinia spp.) Bacterial leaf spot/Bacterial spot, Bacterial wilt (Ralstoniasolanacearum), Bacterial blight (Pseudomonas syringaepv. pisi), Bacterial brown spot (Pseudomonas syringaepv. syringae) and the like. Other bacterial diseases of vegetables include Peppery leaf spot—Pseudomonas syringaepv. maculicola (brassicas), Varnish spot—Pseudomonas spp. (lettuce), Corky root—Rhizomonassuberifaciens (lettuce); Angular leaf spot— P. syringaepv. lachrymans (cucurbits); Bacterial pith necrosis—Pseudomonas corrugata and other bacteria (tomatoes); Commonbacterialblight— Xanthomonascampestrispv.phaseoli (beans), Halo blight—Pseudomonas syringaepv. phaseolicola (beans), Black leg—Erwiniacarotovorapv. atroseptica (potatoes) and the like.

In an aspect, the antimicrobial composition of the present invention is effective as treatment agent for protecting seeds, fruit, tubers, grains and plants against fungal infections as well as against phytopathogenic fungi which occur in the soil. The composition is especially well tolerated by plants and is ecologically safe.

In an aspect, the antimicrobial composition is formulated by the process known in the art.

In another aspect, the present invention provides a method to inhibit or prevent the agricultural crops from infections caused by phytopathogenic microbes comprising applying/injecting the effective amount of the present antimicrobial composition at a concentration ranging from 0.05 to 1.0% (w/w) to the desired parts of the crop or to the soil.

In yet another aspect, the present invention provide synergistic antimicrobial composition/formulation to control the diseases caused by phytopathogenic microbes in agricultural crops comprising the carboxylic acids selected from organic acids such as Pelarganoic acid, Acetic acid, Propionic acid, Lactic acid, Formic acid, Capric acid, Caprylic acid alone or mixtures thereof in an amount of 45 to 80 wt % of the total composition as the active ingredient optionally with an antioxidants and agriculturally acceptable excipients.

The benefits and advantages of the present disclosures will be appreciated and understood by those with ordinary skilled in the art, from the following detailed description.

### DESCRIPTION OF FIGURES

FIG. 1: Depicts the antifungal activity of the composition V of Table 3.

### DETAILED DESCRIPTION OF THE INVENTION

The present invention will now be described in detail in connection with certain preferred and optional embodiments, so that various aspects therefore maybe fully understood and appreciated.

### Definitions

A “weight percent” (w/w %) of a component is based on the total volume of the formulation or composition in which the component is included.

The term “effective amount” of the composition/formulation is meant such amount capable of performing the function or property for which an effective amount is expressed, such as a non-toxic but sufficient amount to provide the desired antimicrobial or antifungal benefits. Thus, an appropriate effective amount may be determined by those with ordinary skill in the art using only routine experimentation.

Source:

The antimicrobial culture used in the present study was collected from NRCP—National Research Center for Pomegranate-Solapur-India.

The Compositions/Formulations can vary not only in the concentration of major components i.e., organic acids, but also in the type of aldehydes, organic acid esters as antioxidants used. This invention can be modified in several ways by adding or deleting from the formulation one of the organic acids, aldehyde and organic acid esters.

The present invention discloses synergistic antimicrobial composition/formulation comprising of carboxylic acids, aldehydes and antioxidants to control the diseases caused by phytopathogenic microbes in agricultural crops.

Accordingly, the present invention discloses synergistic antimicrobial composition/formulation to control the diseases caused by phytopathogenic microbes in agricultural crops, comprising of;
(i) Carboxylic acids selected from organic acids;
(ii) Aldehydes selected from aliphatic or aromatic aldehydes;
(iii) Antioxidants;
   wherein the ratio of carboxylic acids to aldehydes to antioxidants is in the range of 1:0.25:0.01 to 2:1:0.1.

In an embodiment, the antimicrobial composition of the present invention may comprise metal oxides, metal salts, alcohols, sugar alcohols, carbonyl halides, lignosulfonates, silica containing compounds, phosphate and/or phosphite containing compounds in an amount from 0.1 to 10 w/w % of total formulation w/w ratio.

The antimicrobial composition further comprises the agriculturally acceptable excipients which are safe to use and environmentally friendly in weight ratio of 1:0.25 (composition:excipients)

The carboxylic acids in the present composition are selected from organic acids such as Pelarganoic acid, Acetic acid, Propionic acid, Lactic acid, Formic acid, Capric acid, Caprylic acid and such like alone or mixtures thereof at a concentration ranging between 45 to 80 wt % of the total composition.

The aldehydes in the present composition are selected from formaldehyde, cinnamaldehyde, salicylaldehyde, and such like alone or mixtures thereof at a concentration ranging between 2.5 to 25 wt % of the total composition.

The antioxidants are selected from phenolic esters which include but not limited to propyl gallates, hexyl gallate, salicylates alone or mixtures thereof in an amount of 0.1 to 5 wt % of the total composition or the organic acids which include but not limited to ascorbic acid, citric acid and such like alone or mixtures thereof in an amount of 0.1 to 10 wt % of the total composition.

The metal salts include but not limited to sulphates, chlorides, nitrates, phosphates and or metal oxides of Nickel, Cobalt, Iodine, Copper, Zinc, etc., or mixtures thereof which have anti-microbial function in an amount ranging between 0.1% to 10% of total formulation w/w ratio.

The lignosulfates include sodium and or potassium and or magnesium and or copper and zinc and or cobalt lignosulfonates in an amount of 0.1 to 10 wt % of the total composition.

In another embodiment, the present invention relates to synergistic antimicrobial composition/formulation to control the diseases caused by phytopathogenic microbes in agricultural crops, comprising;
(i) Carboxylic acids selected from organic acids which include but is not limited to pelargonic acid, propionic acid, lactic acid, acetic acid, formic acid, capric acid and caprylic acid either alone or mixtures thereof at a concentration ranging between 45 to 80 wt % of total formulation;
(ii) Aldehydes selected from cinnamaldehyde, formaldehyde, salicylaldehyde either alone or mixtures thereof at a concentration ranging between 2.5 to 25 wt % of total formulation;
(iii) Antioxidants selected from phenolic esters which include but not limited to propyl gallates, hexyl gallate, salicylates, sodium nitroprusside at a concentration ranging between 0.1 to 5 wt % of total formulation; or the organic acids which include but not limited to ascorbic acid, citric acid, alone or mixtures thereof at a concentration ranging between 0.1 to 10 wt % of total formulation;
   wherein the ratio of carboxylic acids to aldehydes to antioxidants is in the range of 1:0.25:0.01 to 2:1:0.1.

In an embodiment, the antimicrobial composition of the present invention may comprise metal oxides or metal salts, alcohols, sugar alcohols, carbonyl halides, lignosulfonates, silica containing compounds, phosphate and/or phosphite containing compounds in an amount of 0.1% to 10% of total formulation w/w ratio.

The antimicrobial composition may further comprise the excipients which are safe to use and environmentally friendly in suitable proportion. The excipients are selected from agriculturally-acceptable carrier such as polysorbate; surfactants which include a wetting agent and a dispersant wherein the dispersant is a modified lignin with a high sulfonic acid group content; adjuvants and the like. The excipients are present in the composition in the weight ratio of 1:0.25.

The antimicrobial composition of the present invention is effective against the phytopathogenic fungi belonging to the following classes: Oomycetes (e.g., Pythium, Phytophthora, Peronospora, Albugo); Ascomycetes (e.g., Venturia, Podosphaera, Erysiphe, Monilinia, Uncinula); Basidiomycetes (e.g., the genera Hemileia, Rhizoctonia, Puccinia); Fungi imperfecti (e.g., Botrytis, Helminthosporium, Fusarium, Septoria, Cercospora, Alternaria and, especially, Pyricularia) and the like.

The composition of the present invention primarily controls the bacterial and fungal diseases like Black rot (Xanthomonascampestrispv. campestris), Bacterial canker (Clavibactermichiganensispv. michiganensis), Bacterial soft rot (Pseudomonas spp., Erwinia spp.) Bacterial leaf spot/Bacterial spot, Bacterial wilt (Ralstoniasolanacearum), Bacterial blight (Pseudomonas syringaepv. pisi), Bacterial brown spot (Pseudomonas syringaepv. syringae), and the like. Other bacterial diseases of vegetables include Peppery leaf spot—Pseudomonas syringaepv. maculicola (brassicas), Varnish spot—Pseudomonas spp. (lettuce), Corky root—Rhizomonassuberifaciens (lettuce); Angular leaf spot—P. syringaepv. lachrymans (cucurbits); Bacterial pith necrosis—Pseudomonas corrugata and other bacteria (tomatoes); Common bacterial blight—Xanthornonascarnpestrispv. phaseoli (beans), Halo blight—Pseudomonas syringaepv. phaseolicola (beans), Black leg—Erwiniacarotovorapv. atroseptica (potatoes).

The antimicrobial composition of the present invention can be applied to the plants selected from the group consisting of cucurbit vegetables, peppers, potatoes, carrots, radishes, grapes, Cole crops, leafy vegetables and tomatoes.

In an embodiment, the antimicrobial composition of the present invention is treatment agent for protecting seeds, fruit, tubers, grains and plants against fungal infections as well as against phytopathogenic fungi which occur in the soil. The composition is especially well tolerated by plants and is ecologically safe.

In yet another embodiment, the present invention discloses synergistic antimicrobial composition/formulation to control diseases caused by phytopathogenic microbes in agricultural crops comprising carboxylic acids selected from organic acids such as Pelarganoic acid, Acetic acid, Propionic acid,

Lactic acid, Formic acid, Capric acid, Caprylic acid alone or mixtures thereof in an amount of 45 to 80 wt % of the total composition as the active ingredient optionally with antioxidants and agriculturally acceptable excipients.

In an embodiment, the composition of the present invention comprises the antioxidants and agriculturally acceptable excipients along with farmer practice like with all kinds of N, P, K fertilizers and supplements.

In an embodiment, the antimicrobial composition of the present invention is formulated by the process known in the art using the ingredients that are safe both to the humans and environment.

In an embodiment, the present composition is applied/injected to the crops at a concentration ranging from 0.05 to 1.0%.

In yet another embodiment, the amount of composition applied in the soil varies from 1 kg to 3 kg per acre.

The present composition is applied in such a form that provides a uniform and homogeneous distribution of the mixture throughout the mixed ingredients. The composition is applied to the plants in the form of powder, pellets, granules, liquid, sprays or injection in appropriate amount at said concentration.

In yet another embodiment, the present invention relates to the use of synergistic antimicrobial composition/formulation comprising of carboxylic acids, aldehydes and antioxidants to inhibit or prevent the agricultural crops from infections caused by phytopathogenic microbes.

The composition of the present invention has no phytotoxicity and safe both to the environment and the humans.

### EXAMPLES

### Example 1: Formulation/Compositions

TABLE 1

| | | FIPL-AM | FIPL-AM | FIPL-AM | FIPL-AM | FIPL-AM | FIPL-AM | FIPL-AM | FIPL-AM | FIPL-AM | FIPL-AM |
|---|---|---|---|---|---|---|---|---|---|---|---|
| | | 12000 | 12000- | 12000- | 12000- | 12000- | 12000- | 12000- | 12000- | 12000- | 12000- |
| | | Control | 4 A | 4 B | 4 C | 4 D | 4 E | 4 F | 4 G | 4 H | 4 I |
| S No | Components | (wtin g) | (wt in g) | (wt in g) | (wt in g) | (wt in g) | (wt in g) | (wt in g) | (wt in g) | (wt in g) | (wt in g) |
| 1 | Pelargonic acid | 95 | 95 | 95 | 95 | 95 | 95 | 95 | 95 | 95 | 95 |
| 2 | Acetic acid | 110 | 110 | 110 | 110 | 110 | 110 | 110 | 110 | 110 | 110 |
| 3 | Cinnamaldehyde | 277 | 277 | 277 | 277 | Nil | Nil | 277 | Nil | 277 | 277 |
| 4 | Propionic acid | 261 | 261 | 261 | 261 | 261 | 261 | 261 | 261 | 261 | 261 |
| 5 | Lactic acid | 127 | 127 | 127 | 127 | 127 | 127 | 127 | 127 | 127 | 127 |
| 6 | Formic acid | 130 | 130 | 130 | 130 | 130 | 130 | 130 | 130 | 130 | 130 |
| 7 | N-Propyl gallate | 14 | 14 | 14 | 14 | Nil | 14 | 14 | 14 | 14 | 14 |
| 8 | Hexyl gallate | Nil | 14 | 28 | 56 | Nil | 56 | 56 | 56 | 56 | 56 |
| 9 | Tween-80 | 300 | 300 | 300 | 300 | 300 | 300 | 300 | 300 | 300 | 300 |
| 10 | Sodium Nitro | 20 | 20 | 20 | 20 | 20 | 20 | 20 | 20 | 20 | 20 |
| | prusside | | | | | | | | | | |
| 11 | Sodium ligno | 10 | 10 | 10 | 10 | 10 | 10 | 10 | 10 | 10 | 10 |
| | sulfonate | | | | | | | | | | |
| 12 | Salicylaldehyde | Nil | Nil | Nil | Nil | Nil | Nil | Nil | 277 | Nil | Nil |
| 13 | Ascorbic acid | Nil | Nil | Nil | Nil | Nil | Nil | Nil | Nil | 30 | Nil |
| 14 | Citric acid | Nil | Nil | Nil | Nil | Nil | Nil | Nil | Nil | Nil | 30 |
| | Total volume mL | 1000 | 1000 | 1000 | 1000 | 1000 | 1000 | 1000 | 1000 | 1000 | 1000 |

Note:
FIPL-AM 12000-control, 4A to 4I are composition ID's

General procedure for making composition of antimicrobial formulation as follows:
1a: To 3 liter RB flask was added pelargonic acid acetic acid, propionic acid, lactic acid, formic acid, N-propyl gallate, hexyl gallate, cinnamaldehyde, sodium nitroprusside, sodium lignosulfonates and tween-80 under stirring at 100 rpm for 30 minutes. The resulting solution was used for anti-microbial testing.
1b: To 3-liter RB flask was added pelargonic acid acetic acid, propionic acid, lactic acid, formic acid, N-propyl gallate, hexyl gallate, salicylaldehyde, sodium nitroprusside, sodium lignosulfonates and tween-80 under stirring at 100 rpm for 30 minutes. The resulting solution was used for anti-microbial testing.

### Example 2: Formulations

TABLE 2
Formulations

| | I | II | III | IV | V |
|---|---|---|---|---|---|
| Component | (wt in g) | (wt in g) | (wt in g) | (wt in g) | (wt in g) |
| Pelarganoic acid | 50 | 100 | 100 | 200 | 100 |
| Acetic acid | 100 | 100 | 100 | Nil | 100 |
| Propionic acid | 400 | 350 | 350 | Nil | 250 |
| Formaldehyde | 225 | 225 | Nil | Nil | Nil |
| Cinnamaldehyde | 225 | 225 | 250 | Nil | 250 |
| Lactic acid | Nil | Nil | 100 | Nil | 100 |
| Formic acid | Nil | Nil | 100 | Nil | 100 |
| Capric acid | Nil | Nil | Nil | 300 | Nil |
| Caprylic acid | Nil | Nil | Nil | 500 | Nil |
| Cu—Co-lignosulfonates | Nil | Nil | Nil | Nil | 100 |
| Propyl gallate | Nil | Nil | Nil | Nil | 14 |

Antibacterial Activity

The antibacterial activity of the formulations of example 1 and 2 prepared by the general process were tested against 2 bacterial pathogens (i) Xanthomonasoryzae (X.oryzae) and (ii) Xanthomonas (X. axonopodis).

Experimental Assay Method: In-Vitro Method (Poison-Food Technique) is Used in the Study.

Procedure:
1. 500 mL nutrient agar medium was prepared using distilled water.
2. Each composition viz. FIPL-AM-12000-CONTROL, FIPL-AM-12000-4A, FIPL-AM-12000-4B, FIPL-AM-12000-4C of example 1 and 2 were tested at different concentrations of 0.12%, 0.25% and 0.50% each.
3. Added the test composition of concentration 0.12%, 0.25% and 0.50% each to the nutrient agar medium.
4. 25 mL of molten nutrient agar was added to each petri-plate, after solidification of the same, each of the bacterial pathogens (50 μl culture per plate) was uniformly spread/streaked on nutrient agar plate surface.
5. Plates were incubated for a period of 1 week.
6. Bacterial colonies were observed in each of the plates.
7. Calculated the colony count with positive and negative controls.
8. The antibacterial activity of the compounds based on the controls was determined and results were summarized.

Results: Percentage Inhibition of Microbial Growth

TABLE 3

| | X. oryzae | | | X. axonopodis | | |
|---|---|---|---|---|---|---|
| Compound tested | % Inhibition | | | % Inhibition | | |
| Concentration | 0.12 | 0.25 | 0.5 | 0.12 | 0.25 | 0.5 |
| FIPL-AM-12000- | 100 | 100 | 100 | 90 | 100 | 100 |
| CONTROL | | | | | | |
| FIPL-AM-12000- 4 A | 100 | 100 | 100 | 90 | 100 | 100 |
| FIPL-AM-12000- 4 B | 100 | 100 | 100 | 90 | 100 | 100 |
| FIPL-AM-12000- 4 C | 100 | 100 | 100 | 100 | 100 | 100 |

| | | |
|---|---|---|
| Negative control | 0 | 0 |

Result Summary:
1. All the 4 samples inhibited the growth of X. oryzae in all the three concentrations tested (100% inhibition)
2. Percentage of inhibition was 90% with all the 3 compositions tested against X. axonopodis at 0.25% concentration.
3. Both bacterial pathogens (X. oryzae and X. axonopodis) were 100% inhibited with the composition FIPL-AM-12000-4C.

TABLE 4

| | X. oryzae | | | X. axonopodis | | |
|---|---|---|---|---|---|---|
| Compound tested | % Inhibition | | | % Inhibition | | |
| Concentration | 0.12 | 0.25 | 0.5 | 0.12 | 0.25 | 0.5 |
| FIPL-AM-12000- | 100 | 100 | 100 | 90 | 100 | 100 |
| Control | | | | | | |
| FIPL-AM-12000-4D | 60 | 65 | 75 | 60 | 65 | 75 |
| FIPL-AM-12000-4E | 72 | 76 | 76 | 52 | 65 | 68 |
| FIPL-AM-12000-4F | 90 | 93 | 100 | 92 | 94 | 100 |
| FIPL-AM-12000-4G | 90 | 93 | 100 | 92 | 94 | 100 |
| FIPL-AM-12000-4H | 100 | 100 | 100 | 100 | 100 | 100 |
| FIPL-AM-12000-4I | 100 | 100 | 100 | 100 | 100 | 100 |

| | | |
|---|---|---|
| Negative control | 0 | 0 |

### Example 4: Antifungal Activity

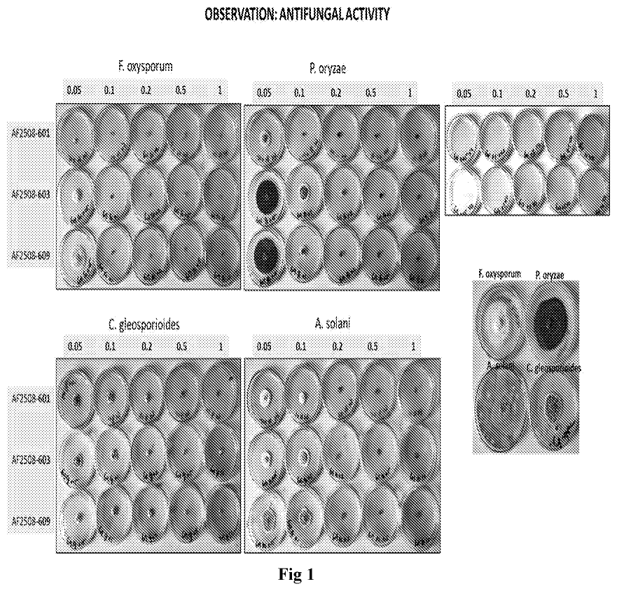

The antifungal activity of the composition V at a concentration 0.12% and 0.25% tested in vitro for foliage as well as field applications is depicted in FIG. 1.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A synergistic antimicrobial composition to control the diseases caused by phytopathogenic microbes in agricultural crops, comprising:
(i) Carboxylic acids selected from organic acids which include but is not limited to pelargonic acid, propionic acid, lactic acid, acetic acid, formic acid, capric acid and caprylic acid either alone or mixtures thereof at a concentration ranging between 45 to 80 wt % of total formulation;
(ii) Aldehydes selected from cinnamaldehyde, formaldehyde, salicylaldehyde either alone or mixtures thereof at a concentration ranging between 2.5 to 25 wt % of total formulation;
(iii) Antioxidants selected from phenolic esters which include but not limited to propyl gallates, hexyl gallate, salicylates, sodium nitroprusside at a concentration ranging between 0.1 wt % to 5 wt % of total formulation; or the organic acids which include but not limited to ascorbic acid, citric acid, alone or mixtures thereof at a concentration ranging between 0.1 wt % to 10 wt % of total formulation;
wherein the ratio of carboxylic acids to aldehydes to antioxidants is in the range of 1:0.25:0.01 to 2:1:0.1.

2. The synergistic antimicrobial composition as claimed in claim 1, wherein the composition may comprise metal oxides or metal salts, alcohols, sugar alcohols, carbonyl halides, lignosulfonates, silica containing compounds, Phosphate and/or phosphite containing compounds in an amount of in an amount of 0.1% to 10% of total formulation w/w ratio.

3. The synergistic antimicrobial composition as claimed in claim 1, wherein the composition comprises agriculturally acceptable excipients with the weight ratio of 1:0.25 (composition:excipients).

4. The synergistic antimicrobial composition as claimed in claim 1, wherein the composition is applied/injected to the agricultural crops at a concentration ranging from 0.05 to 1.0%.

5. The synergistic antimicrobial composition as claimed in claim 1, wherein the composition is effective against the diseases caused by the phytopathogenic microbes in agricultural crops for protecting seeds, fruits, vegetables and plant cuttings against microbial infections and against phytopathogenic microbes present in the soil.

6. The synergistic antimicrobial composition as claimed in claim 1, wherein the composition is ecologically safe.

7. A method to inhibit or prevent an infection of an agricultural crop caused by phytopathogenic microbes, the method comprising applying/injecting an effective amount of an antimicrobial composition a according to claim 1 to the agricultural crop or to the soil.

8. A synergistic antimicrobial composition to control the diseases caused by phytopathogenic microbes in agricultural crops comprising carboxylic acids selected from organic acids which include but is not limited to pelargonic acid, propionic acid, lactic acid, acetic acid, formic acid, capric acid and caprylic acid either alone or mixtures thereof as active ingredient in an amount ranging between 45 to 80 wt % of total formulation.

9. The synergistic antimicrobial composition as claimed in claim 1, wherein the composition comprises antioxidants and agriculturally acceptable excipients along with farmer practice like with all kinds of N, P, K fertilizers and supplements.
